(19) United States
(12) Patent Application Publication
(10) Pub. No.: US 2012/0138812 A1
(43) Pub. Date: Jun. 7, 2012

(54) DEVICE AND METHOD FOR ANALYZING THE DENSITY OF A BEAM OF CHARGED PARTICLES

(75) Inventor: Peter Johan OVING, Voreppe (FR)

(73) Assignee: TECHNIQUES METALLURGIQUES AVANCESS (TECHMETA), Metz Tessy (FR)

(21) Appl. No.: 13/313,181

(22) Filed: Dec. 7, 2011

(30) Foreign Application Priority Data
Dec. 7, 2010 (FR) 10 60194

(51) Int. Cl. G01T 1/16

(52) U.S. Cl. 250/395; 250/336.1

(57) ABSTRACT

A device and method for analyzing the current density in an incident beam F of charged particles, using a rotary target 2 pierced with holes 7. Such a device and the associated processing elements make it possible to reconstruct a 3D image of the current density without using a tomographic method.

The present invention relates to the field of measuring devices, in particular devices for measuring the diameter and shape of an ion or electron beam, in particular in tools such as an ion implanter or an electron beam welding device.

Electron beam machines have found various applications, in particular in the fields of welding, surface modification, X ray generation, electron beam lithography, electronic microscopy, and many others. With these applications came the need for precise control of the focus and alignment of the beam, as well as a particular need to determine the distribution of energy in an electron beam.

The production of reproducible electron beams can be done independently of the machine or operator if the energy distribution of the beam can be controlled and known precisely. The traditional methods for adjusting the energy distribution are based on the know-how of an operator specialized in welding who visually adjusts the beam on a secondary target. The operator looks at the intensity of the radiation from the light given off rather than a direct measurement of the energy distribution of the beam. This old method is inherently imprecise, requiring an experienced operator and precise judgment to focus the beam correctly. Clearly each operator can adjust the parameters differently depending on the interpretation each has of what he sees.

The current density in question is influenced by many variables, such as the shape of the cathode, focus adjustments, the firing distance, the value of the current, the accelerating voltage, the vacuum level, and the alignment of the electrodes. A variation of these parameters can cause a variation in the distribution of the current density of the beam, which can have a significant effect on the penetration of the welding, the width of the weld seam and the quality of the surface of the objects welded by the electron beam.

The traditional methods for adjusting the beam are not fully satisfactory. Various devices have been developed to determine various characteristics of the electron or ion beams, such as the configuration of the beam, the current density, etc. among the different devices, the rotary yarn probe, pinhole devices, the modified Faraday cage, the modified and improved Faraday cage, the double rotary slotted disk scanner.

These quantitative diagnostic means were intended to better determine the distribution of the current density, and thereby provide better monitoring the conditions of the focus of the beam. To obtain the most realistic image of the current density of the electron beam, the beam should ideally be located at rest without scanning above an analysis tool (this scanning is, however, used with tools of the rotary yarn type and the modified and improved Faraday cage).

The invention aims to propose a device and a method for analyzing a beam of charged particles, in particular an electron or ion beam, making it possible to determine the distribution of the current density, therefore of the power, in a section of the beam. Furthermore, the invention aims to propose a solution not using tomographic reconstruction.

According to a first object of the invention, such a device for analyzing the current density in an incident beam of charged particles is characterized in that it comprises a moving target, the target being positioned to project the beam there during analysis, at least one hole passing through the moving target and arranged so that each hole passes through a section of the beam along a respective path when the target moves and only a fraction of the incident beam passes through the target via the hole, and means for measuring the current density of the fraction.

Preferably, the target rotates around an axis, and the travel of each hole is an arc of circle centered on the axis. The target advantageously comprises at least one reference hole, the section of the reference hole being noticeably different from, preferably twice, the section of the at least one hole. The target can comprise several holes, the arcs of circle passed through by the holes preferably being regularly radially spaced apart. The arcs of circle passed through by the holes can also be radially closer in an intermediate zone and radially further apart on either side of said intermediate zone. The holes may or may not be regularly angularly spaced apart from one another.

Preferably, the means for measuring the current density of the fraction comprise at least one Faraday cage.

The device can also comprise a primer target, preferably cooled. The device can then comprise means for deflecting the beam to be analyzed, incident, toward the primer target.

According to a second object of the invention, a method for analyzing the current density in a section of an incident beam of charged particles is characterized in that it comprises steps for:
measuring a current density profile in fractions of the incident beam, said profile corresponding to at least one route in the analyzed section; and
reconstructing the current distribution in said section from said profile.

To measure the profile, it is possible to move a target pierced with at least one hole between the beam and means for measuring the current density in the fractions, and in that each fraction is an instantaneous fraction of the beam passing through one of the holes.

The target can be a target rotating around an axis pierced with at least one series of several holes, the holes preferably being regularly distributed, radially and/or angularly, relative to the axis, the holes having an identical section to one another. The target advantageously comprises a reference hole having a different section from that of the other holes, so that the route of said reference in the analyzed section causes an anomaly in the profile, so that one verifies that the analysis is complete while ensuring that two anomalies appear in the profile. The appearance of two successive anomalies can be used to determine the actual speed of rotation of the target during the analysis.

The method according to the invention can also comprise steps to:
position the beam (F), preferably unfocused, with a low current and not deflected, on the target (2), said target (2) being a rotary target; then
deflect the beam toward a primer target (9); then
increase the power of the beam until reaching its nominal power and a thermal equilibrium of said beam; then
when the speed of rotation of the rotary target (2) is stabilized, stop the deflection of the beam; and
acquire the profile during a given time, preferably substantially corresponding to two target revolutions (2); then
again deflect the beam toward the primer target (9); then
extinguish the beam and stop the rotation of the target (2).

The method can also comprise at least one step for calculating at least one parameter of the beam among the full width at half-maximum, the full width at height 1/e², the maximum surface power density.

Such a method can be used in a method for determining wear of an electrode of a charged particle beam generator.

Such a method can also be used in a method for determining an alignment flaw of an electrode of a charged particle beam generator.

Such a method can also be used to determine an optimal focus of the beam.

Several embodiments of the invention will be described below, as non-limiting examples, in reference to the appended drawings, in which:

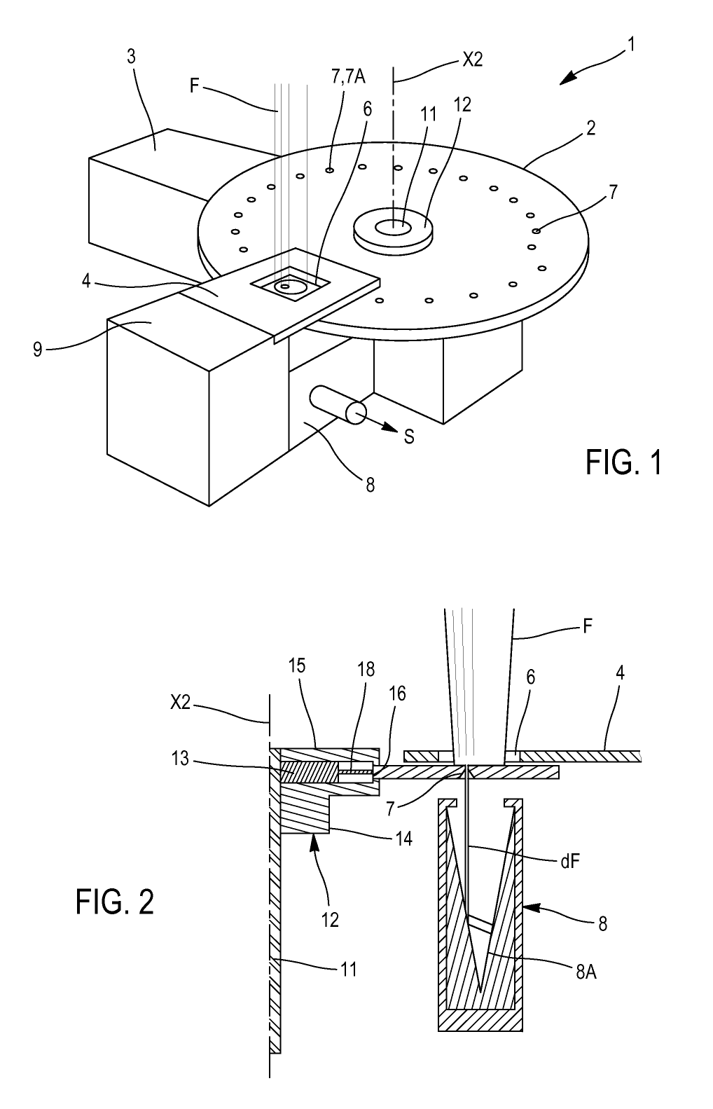

FIG. 1 is a diagrammatic perspective view of a first embodiment for a device according to the invention intended to measure intensities of a beam of charged particles through a section of that beam, device comprising a rotary plate provided with “pinholes”;

FIG. 2 is a partial and diagrammatic half-section of the device of FIG. 1, at a Faraday cage, the beam being shown there passing through one of the pinholes;

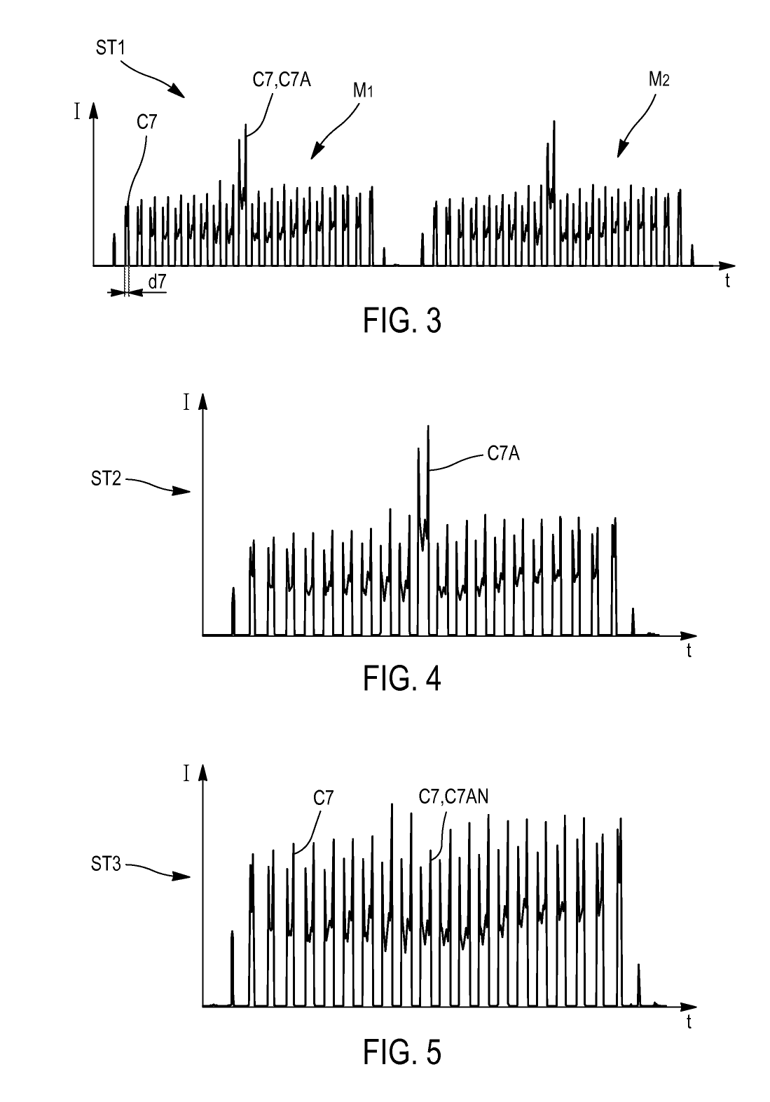

FIG. 3 illustrates the values of a signal measured with the device of FIG. 1, during two revolutions of the plate;

FIG. 4 illustrates values, taken from those of FIG. 3, corresponding to a single revolution of the plate;

FIG. 5 illustrates corrected values taken from the values of FIG. 4;

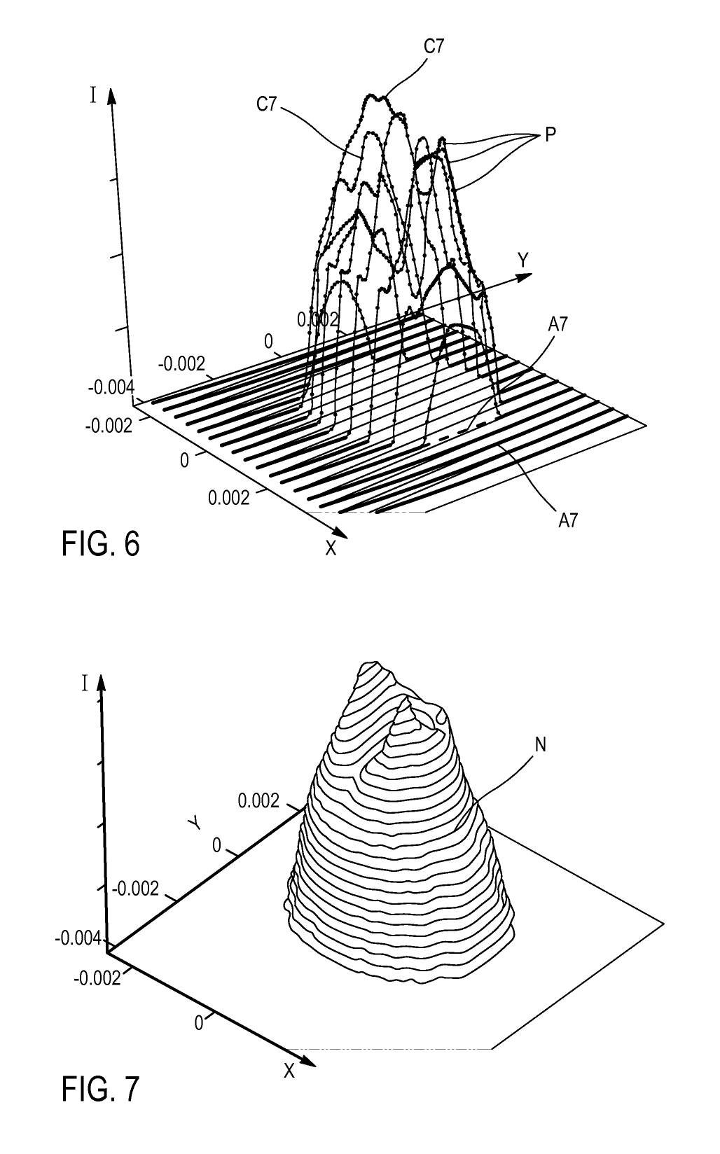

FIG. 6 is an illustration of the values of FIG. 5 according to their position relative to the section of the beam;

FIG. 7 illustrates a spatial reconstruction, in three dimensions and with level curves of the distribution of the intensity of the beam according to its section, deduced from that of FIG. 6;

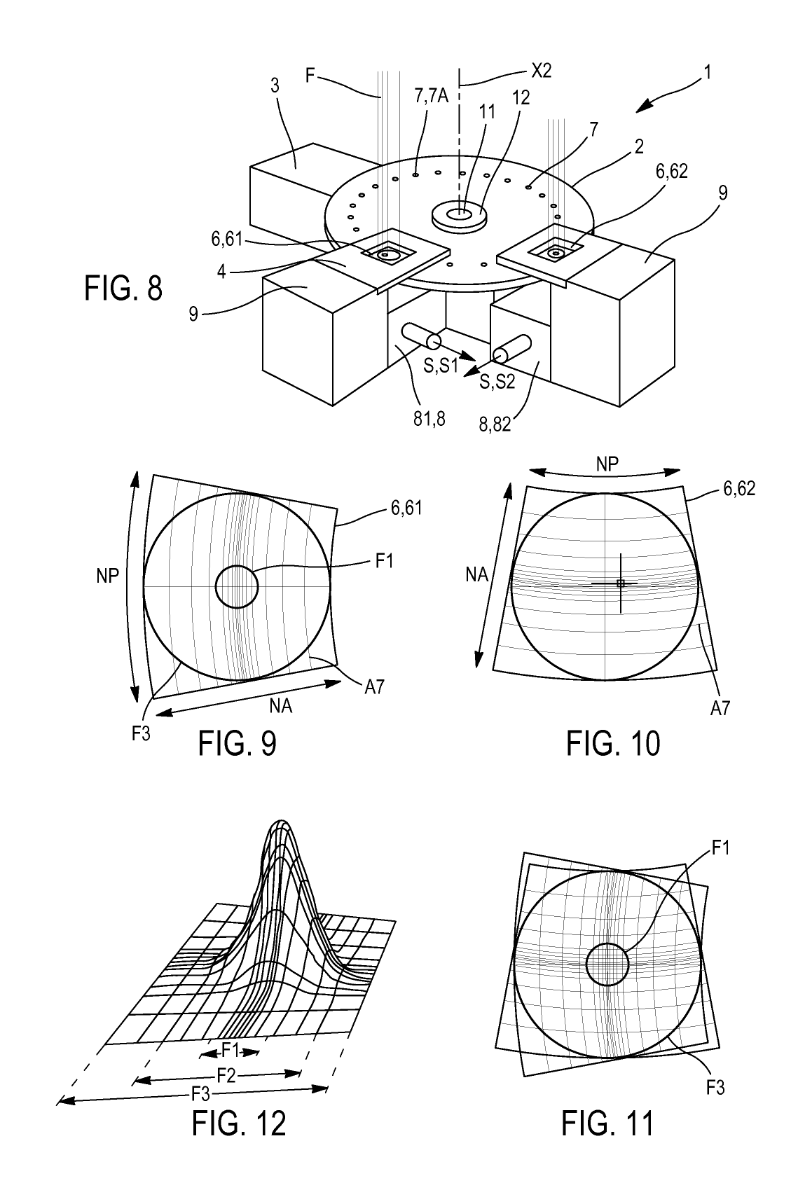

FIG. 8 is a view similar to that of FIG. 1, of a second embodiment of a device according to the invention, which comprises two Faraday cages;

FIGS. 9 and 10 illustrate routes at each of the Faraday cages of the device of FIG. 8;

FIG. 11 illustrates a superposition of the routes of FIGS. 9 and 10; and

FIG. 12 illustrates a spatial reconstruction from measurements done with the device of FIG. 8.

FIG. 1 illustrates a device 1 according to the invention, provided to analyze a beam F of charged particles. In the illustrated example, the beam F is an electron beam.

In the example illustrated in FIGS. 1 and 2, the beam F is assumed to fire vertically from top to bottom. The relative positions of the elements of the device are therefore given according to this hypothesis. Of course, the same device can assume other positions, depending on the firing directions of beams to be analyzed.

In the illustrated example, the device 1 comprises a motorized target 2, and a motor 3 to move said target. The device also comprises a window 4, through an opening 6 from which the beam is fired, a Faraday cage 8 to receive a filtered part dF of the beam F, and a secondary primer target 9.

The motorized target 2 is essentially made up of a plate 2 in the shape of a disk. The disk 2 is mounted rotating around an axis of revolution X2. The axis X2 is substantially combined with the geometric axis of the disk. The axis X2 is positioned substantially parallel to the firing direction of the beam F, i.e. substantially vertically. The motor 3 is provided to rotate the disk 2 around the axis X2. The motor 3 is also provided to rotate the target 2 at a constant speed during the analysis of the beam F.

The window 4 forms an opening 6, above the target 2, near the periphery of the disk. The window 4 forms, around the opening 6, a protection for the target 2 when the beam is not in position to be analyzed, i.e. when the beam is not oriented vertically in the space delimited by the opening 6.

The target is pierced with “pinholes” 7, i.e. it is pierced with through holes 7 with small dimensions relative to the diameter of the beam F to be analyzed. In the illustrated example, the holes 7 are regularly positioned, such that during a complete rotation of the target 2, each travels through the opening 6 along an arc of circle specific to it, the arcs of circle being radially spaced apart from one another, regularly, i.e. the distance between two neighboring arcs is constant. In the illustrated example, the dimensions of the opening are such that the arcs of circle can potentially be likened to straight segments if the required precision is not too high. The holes are also angularly spaced apart regularly, i.e. the angle, relative to the axis X2, between two successive holes is constant. Preferably, the holes are regularly distributed over 360 degrees around the axis X2. Thus, the orifices 7 are positioned in a spiral shape. The holes are advantageously positioned so that there is never more than one hole 7 passing through the opening 6 at the same time. In particular, the size of the opening 6 is chosen so that the analyzed beam only sees one rotating hole at a time.

All of the holes 7 have circular horizontal sections substantially identical to one another, except one orifice 7A. The orifice 7A is a hole forming a reference. It has different dimensions from those of the other holes, so that it provides an indication of the relative position of the target 2 relative to the beam, each time that hole 7A passes through the opening 6. Thus, if the reference 7A has a section substantially larger than that of the other holes 7, it will also receive a noticeably larger quantity of electrons. For example, if the reference has an inlet section twice that of the other holes, it will receive substantially twice as many electrons as expected. In the illustrated example, the dimensions of the reference 7A differ from those of the other holes in that they are doubled in the direction of the corresponding arc. Preferably, the reference is positioned so that it travels through a central region of the window. One thus avoids it passing through a peripheral region, not very large, with low intensity, or without the analyzed beam.

The rotation of the target 2 makes it possible to distribute, over a large surface area, the energy transmitted to the target by the beam F during the measurements. Nevertheless, the material used for the disk is very advantageously of the refractory type. It can in particular be made from tungsten, molybdenum or graphite. If it is made from graphite, it can include only graphite or comprise, on its upper surface, a deposition or projection of a refractory material such as tungsten or molybdenum. The deposition or projection of a refractory metal leads to increasing the number of secondary electrons (“electrons bouncing” from the surface), thereby reducing the thermal charge of the disk, which makes it possible to use the device 1 to analyze the beams F with higher powers.

Advantageously, the device is equipped with a current collector (not shown in the figures) of the coal type in contact with the target, to continuously evacuate the current intercepted during the analysis.

As particularly illustrated in FIG. 2, the target 2 is fixed on a shaft 11 with axis X2 via a hub 12. The temperature of the target increases greatly during measurements, inasmuch as it absorbs part of the energy transmitted to it by the beam F. The hub 12 is therefore advantageously designed to limit the heat dissipation to the other elements of the device 1. In the illustrated example, the hub 12 comprises centering means 13 and maintenance means 14, 15. The maintenance means comprise a lower clamp 14 and an upper clamp 15, all three mounted on the shaft 11. The lower clamp 14 is mounted secured in rotation with the shaft 11 so that it completely and rigidly transmits the rotational movement of the shaft 11 to the target 2. The lower and upper clamps 14, 15 respectively bear on a lower surface and an upper surface of the target along an inner edge 17. The upper clamp 15 is positioned to make the target 2 integral, by clamping, with the lower clamp 14, in rotation and translation.

The centering means are formed by a piece 13 adjusted on the shaft, between the clamps 14, 15. The piece comprises an annular part 18 with a reduced thickness that bears against the inner edge 16 of the target 2.

The upper clamp 15 and the centering piece 13 can be disassembled from the shaft 11, in particular to make it possible to change the target 2.

Preferably, the contact of the clamps and the centering piece are not continuous along the inner edge 16, so that this limits the thermal transmission. To the same end, empty spaces are also provided on either side of the annular zone 18, between it and each of the clamps 14, 15.

As particularly shown in FIG. 2, when the incident beam F strikes the target 2 at the location of a hole 7, the target plays a filter role, so that only a filtered part dF of the beam F is diffused through the target 2 via the hole 7. From top to bottom, the hole illustrated in FIG. 2 first has a cylindrical portion, then a tapered portion widening considerably toward the bottom. Such an arrangement is particularly advantageous to avoid a noticeable interception of the electrons by the walls of the hole 7.

The Faraday cage 8 is positioned under the target 2, opposite the opening 6, so that, irrespective of the hole 7 passing through the opening, the filtered part dF that it diffuses is still absorbed by the Faraday cage. The Faraday cage 8 has an inner configuration in the form of a conical well 8A so that the electrons are trapped there. In the example illustrated in FIG. 8, the inclined inner surfaces of the Faraday cage make it possible to minimize the losses of secondary and back scattered electrons. Thus, the Faraday cage is built so as to collect all of the beam current transmitted via the pinholes while avoiding the loss of back scattered or secondary electrons as much as possible.

As illustrated in FIG. 1, the device 1 comprises an output S for an electric signal substantially proportional to the instantaneous flow of electrons absorbed by the Faraday cage.

In the illustrated example, the target 9 is a cooled target. During priming thereof, the beam is deflected there for long enough to stabilize, then, after measurement, its extinction time. One thus limits the exposure time of the rotary target to the time needed for measurements.

The device 1, in particular formed by the motorized target 2, the motor 3, the window 4, the Faraday cage 8 and the primer target 9, therefore constitutes a scanner for the electron beam F. Means can be provided in the device 1 to deflect the incident beam F toward the primer target. It is also possible to use deflecting means provided in the source of the beam F. The deflection means can be magnetic field means.

Although not shown in the figures, the device 1 according to the invention can advantageously comprise acquisition means for the signal coming from the output S and means for processing that signal; in particular, these means can respectively comprise acquisition software and processing software for the specific signal. Such a device 1 can also comprise control means for the motor and, if applicable, control means for the deflection means of the incident beam F. Preferably, all of the operations—rotation of the disk, triggering of the acquisition, priming and extinguishing the beam, deflection of the beam, etc.—are managed by a programmable machine.

The device can also comprise means to be moved along several axes, so as to be positioned relative to the beam F.

We will now describe the successive steps of analyzing the beam F using the illustrated device.

First, the target 2 being in rotation, the beam is kept non-deflected and at a low power, toward the target 2. The centering of the opening 6 of the window 4, on the non-deflected beam, is verified, then potentially corrected.

One then deflects the beam F toward the cooled target 9, the time needed to prime it, i.e. the time needed for it to reach its nominal power and a thermal equilibrium.

Then, one stops the deflection of the beam F, so that it strikes the rotary target 2, in a zone delimited by the window 4, inside the opening 6, as illustrated in FIGS. 1 and 2; the acquisition of the signal S is triggered substantially at the same time. The beam is thus left directed for the time necessary for the target 2 to perform two revolutions; the signal S coming from the Faraday cage 8 is collected during those two revolutions.

One then deflects the beam F again toward the cooled target 9, the time for it to be extinguished.

The signal S can be processed as it is acquired or deferred after prior recording. FIGS. 3 to 5 illustrate a processing mode provided for the signal S. It will be noted that FIGS. 3, 4 and 5 are not to the same scale.

FIG. 3 illustrates a first outline ST1 showing a profile with intensity I measured as a function of time t. The outline ST1 can result from a first processing of the values of the signal S measured during the two revolutions. It will be noted that the outline ST1 reproduces two patterns M1, M2, respectively corresponding to the first and second revolutions. Each of the patterns comprises a series of peaks C7 with duration d7 corresponding to the travel of a respective hole 7 through the beam F. The duration d7 is longer as the arc of circle passed through by the hole 7 in the beam F is closer to the middle of the beam F. It will be noted that the peak C7A, corresponding to the reference 7A, assumes the form of an anomaly between other peaks. In fact, the section of the reference hole 7A being substantially twice that of the other holes 7, the number of electrons crossing it, therefore the measured intensity I, is substantially doubled. The presence of two anomalies C7A on the outline ST1 makes it possible to ensure that the corresponding measurement has indeed been done on at least one revolution, i.e. the set of holes has indeed crossed the opening 6 and the beam has indeed been completely scanned. For better clarity, the outline ST1 is formed by two complete patterns M1, M2. Nevertheless, in a general case, the outline ST1, if it corresponds to two revolutions, is formed by a first partial pattern, a second complete pattern, and a third partial pattern, complementary to the first.

FIG. 4 illustrates a second outline ST2. The outline ST2 comes from a second processing, applied to the values of the first outline ST1, so that one only keeps the values (t,I) representative of a single revolution. These representative values can, for example, be the exact values between two successive anomalies C7A, averages of the values of two patterns M1, M2, or the exact values of one of the patterns M1 or M2. The outline ST2 comprises all of the information necessary for an intensity distribution analysis inside the scanned section of the beam F, except that it is necessary to correct the anomaly C7A. The number of acquisitions, i.e. the number of peaks appearing, therefore the number of holes 7 having crossed the beam, is determined using the successive peaks C7A; this makes the procedure less dependent on the speed of rotation of the target 2.

FIG. 5 illustrates a third outline ST3. The outline ST3 results from a third processing during which the values of the anomaly C7A are normalized, so that they correspond to those that would have been measured by a hole 7 of standard section. In the case at hand, the values of the peak C7A have been divided by 2. Thus, in the outline ST3, the anomaly C7A is replaced by a corresponding peak C7AN, the values of which are normalized relative to that of the anomaly C7A.

FIG. 6 illustrates a first spatial reconstruction, i.e. a three-dimensional image, of the intensities I of the outline ST3 relative to the position of the measurements relative to a portion of plane XY, in which the portion XY represents the opening 6 of the window 4. Thus, FIG. 6 is a reconstruction of the analyzed section of the beam F, and, for each measurement done, of the intensity measured and the location of the section where that intensity was measured, relative to the window 4. In this first spatial reconstruction, each peak C7 is represented there so that its projection on the portion of plane XY is an arc of circle A7 corresponding to the travel of the respective hole 7, opposite the opening 6. The representation of each peak is discretized there in the form of points P, then reconstructed by computer from those points P.

FIG. 7 is a second spatial reconstruction of the intensities I of the outline ST3, substantially identical to the illustration of FIG. 6, except in that the intensity values have been interpolated there between the curves of the peaks C7; in this way, the intensity values are represented there by a continuous surface and referenced by the curves of level N. FIG. 7 is therefore an image of the current density distribution, therefore the power distribution, in the analyzed section of the beam F, the analyzed section being the one in contact with the upper surface of the target 2. Preferably, the analyzed section is at least close to an active section of the beam F when it is used, for example for welding.

The steps for acquiring and processing the signal S, in particular those illustrated in FIGS. 3 to 5, are advantageously automated. A later step for calibrating the machine emitting the beam F can also advantageously be automated. This can be the case if the machine is intended to weld two pieces together; thus, the travel of the beam F can be defined, as a function of a current density analysis performed beforehand, so that the welding is optimized.

We will now describe, in reference to FIGS. 8 to 12, a second embodiment for a device 1 according to the invention, inasmuch as it differs from the device previously described in reference to FIGS. 1 to 7.

In this embodiment, there are two detection devices, here two Faraday cages 8, the second Faraday cage 82 being positioned at 90 degrees, relative to the axis X2, from the first Faraday cage 81, as illustrated in FIG. 1. The first and second Faraday cages are positioned opposite a first window 61 and a second window 62, respectively.

Furthermore, in this second embodiment, and as particularly illustrated in FIGS. 9 and 10, the radial spacing between each hole 7 of the target 2, therefore between each corresponding arc-shaped route A7, varies. In the illustrated example, the arcs A7 are closer together as they come closer to the middle of a window 6. This arrangement is particularly advantageous, since it makes it possible to analyze indifferently, with the same rotary target and with sufficient precision, beams having a small diameter F1 (see FIGS. 9, 11 and 12), an average diameter F2, or a larger diameter F3, without excessively increasing the number of holes and measurements, in particular in the case of beams with a large diameter F3. Thus, in particular, the device 1 is advantageously positioned so that a fine beam, of type F1, is analyzed by the holes 7 situated in the zone of the target where their routes A7 are the closest together.

In particular when such a target 2, with a variable radial pitch, is used with a device 1 of the first embodiment, as illustrated in FIG. 1, the analysis has a particularly pronounced imbalance, between a number of radial measurements corresponding to the numbers of arcs NA and a number of measuring points NP on each arc, possible through a window 6. For example, one can typically have, in the examples illustrated in FIGS. 9 to 11, NA=17 and 150<NP<200.

Owing to the second embodiment, and to the use of the two Faraday cages 81, 82 positioned at 90 degrees relative to one another, it is therefore possible to scan, i.e. analyze, the beam F in two substantially perpendicular directions. Each analysis has corresponding routes A7 respectively illustrated by FIGS. 9 and 10. These routes can be superimposed to form a grid of the section of the analyzed beam F, as illustrated in FIG. 11.

FIG. 12 illustrates the reconstruction of a distribution of the intensities in the case of a medium-diameter beam of type F2, from the signals S, S1, S2, respectively, coming from the first and second Faraday cages 81, 82.

In the example illustrated in FIG. 8, a primer target 9 is provided associated with each of the Faraday cages. Nevertheless, it is possible to provide only one primer target 9, for example arranged angularly between the two Faraday cages 81, 82.

Preferably, means are provided (not shown in the figures) to position the device 1, with sufficient precision in light of the precision desired for the analysis, so that the analysis is always done when the beam F is not deflected, whether with the first or second Faraday cage. Thus, the first window 61 is positioned in the axis of the non-deflected beam F, then, a first series of measurements being done, the device is moved to position the second window in the same axis of the non-deflected beam, before performing a second series of measurements.

The positioning is preferably precise enough to be able to directly superimpose the two series of measurements. Nevertheless, a correction can be provided, for example by comparing measurements that should be substantially identical, in particular at the intersections of the routes, during the superposition.

Of course, the invention is not limited to the examples described above.

In particular, if in the illustrated example the measurements are done on two complete revolutions, it is also possible to detect a first and second appearance of the measurement peak corresponding to the reference, and to immediately interrupt the measurement after the appearance of the second peak. It is thus possible to limit the exposure of the target to the beam.

In the illustrated example, the reference travels through a region of the beam F specific to it, i.e. the measurements that are done through said hole participate, after normalization, in the analysis. Nevertheless, the reference can also be provided to travel through a region that may or may not already have been traveled through by another hole, so that the reference no longer participates in the analysis, but only performs its reference function.

The device can also comprise means for measuring speed variations on the disk during an analysis, so as to be able to then correct the measurements done as a function of these speed variations.

The holes can have a solely tapered shape, i.e. not comprise a cylindrical portion.

The rotary target can comprises several series of holes and each series can form a respective spiral. Each of these spirals can be radially offset and have holes with different dimensions relative to one another. In that case, the Faraday cage can have sufficient dimensions to be used for all of the spirals. A specific Faraday cage can also be provided for each of the spirals. Each of the spirals can have a use dedicated, for example, to a type of beam with a specific diameter or intensities, or according to the desired precision.

The angular spaces between the holes, relative to the axis, may or may not be regular. The radial distance between the holes can increase or decrease relative to the axis.

An irregular radial or angular spacing can in particular make it possible to process, with a same target and a same spiral, beams having different characteristics; for example, a portion of the spiral having a wide spacing making it possible to analyze wide beams, such as natural or unfocused beams, and another of the spiral have a smaller spacing making it possible to analyze thin beams. Thus, the interval between the holes may, but non-limitingly, be larger at the beginning and end of the spiral, and may be smaller in an intermediate part of the spiral, as illustrated in the second embodiment.

A spacing table for the holes is advantageously used to reconstruct the intensities of the beam, so that an irregular spacing does not affect the result. Although all or part of the irregularity results from tolerance during the machining of the target, it can thus be compensated by a precise geometric reading reflected by the table.

Advantageously, the rotary target is interchangeable, for example to be able to use targets whereof the holes have a spacing, radial or angular, and/or diameters, that are different according to each target, depending on the desired precision and/or the transverse dimensions of the beam to be analyzed.

1. A device (1) for analyzing the current density in an incident beam (F) of charged particles, characterized in that it comprises a moving target (2), said target being positioned to project the beam (F) there during analysis, at least one hole (7) passing through the moving target (2) and arranged so that each hole (7) passes through a section of the beam along a respective path when the target (2) moves and only a fraction (dF) of the incident beam (F) passes through the target via said hole (7), and means (8) for measuring the current density of the fraction (dF).

2. The device according to claim 1, characterized in that the target rotates around an axis (X2), and in that the travel of each hole (7) is an arc of circle centered on the axis (X2).

3. The device according to claim 2, characterized in that it comprises at least one reference hole (7A), the section of the reference hole (7A) being noticeably different from, preferably twice, the section of the at least one hole (7).

4. The device according to claim 2, characterized in that it comprises several holes (7), the arcs of circle passed through by the holes (7) preferably being regularly radially spaced apart.

5. The device according to claim 4, characterized in that the arcs of circle passed through by the holes (7) are radially closer in an intermediate zone and radially further apart on either side of said intermediate zone.

6. The device according to claim 2, characterized in that it comprises several holes (7), the holes (7) preferably being regularly angularly spaced apart.

7. The device according to claim 1, characterized in that the means for measuring the current density of the fraction (dF) comprise at least one Faraday cage (8).

8. The device according to claim 1, characterized in that it comprises a primer target (9), preferably cooled.

9. The device according to claim 8, characterized in that it comprises means for deflecting the beam to be analyzed, incident, toward the primer target (9).

10. A method for analyzing the current density in a section of an incident beam (F) of charged particles, characterized in that it comprises steps for:
measuring a current density profile (ST1) in fractions (dF) of the incident beam, said profile corresponding to at least one route (A7) in the analyzed section; and
reconstructing the current distribution in said section from said profile (ST1).

11. The method according to claim 10, characterized in that to measure the profile, one moves a target (2) pierced with at least one hole (7) between the beam (F) and means (8) for measuring the current density in the fractions (dF), and in that each fraction (dF) is an instantaneous fraction of the beam passing through one of the holes (7).

12. The method according to claim 11, characterized in that the target is a target (2) rotating around an axis (X2) pierced with at least one series of several holes (7), the holes (7) preferably being regularly distributed, radially and/or angularly, relative to the axis (X2), the holes (7) having an identical section to one another.

13. The method according to claim 12, characterized in that the target comprises a reference hole (7A) having a different section from that of the other holes (7), so that the route of said reference (7A) in the analyzed section causes an anomaly (C7A) in the profile (ST1), and in that one verifies that the analysis is complete while ensuring that two anomalies appear in the profile (ST1).

14. The method according to claim 13, characterized in that the appearance of two successive anomalies (C7A) can be used to determine the actual speed of rotation of the target (2).

15. The method according to claim 10, characterized in that it also comprises steps to:
position the beam (F), preferably unfocused, with a low current and not deflected, on the target (2), said target (2) being a rotary target; then
deflect the beam toward a primer target (9); then
increase the power of the beam until reaching its nominal power and a thermal equilibrium of said beam; then
when the speed of rotation of the rotary target (2) is stabilized, stop the deflection of the beam; and
acquire the profile during a given time, preferably substantially corresponding to two target revolutions (2); then
again deflect the beam toward the primer target (9); then
extinguish the beam and stop the rotation of the target (2).

16. The method according to claim 10, characterized in that it comprises at least one step for calculating at least one parameter of the beam among the full width at half-maximum, the full width at height 1/e², the maximum surface power density.

17. A method for determining wear of an electrode of a charged particle beam generator, characterized in that a method according to claim 10 is used.

18. A method for determining an alignment flaw of an electrode of a charged particle beam generator, characterized in that a method according to claim 10 is used.

19. A method for determining an optimal focus of the beam, characterized in that a method according to claim 10 is used.
